(19) United States
(12) Patent Application Publication
(10) Pub. No.: US 2002/0059620 A1
(43) Pub. Date: May 16, 2002

(54) Selective inactivation and copy-protection

(76) Inventor: Khoi Nhu Hoang, Pleasanton, CA (US)

Correspondence Address: OPPENHEIMER WOLFF & DONNELLY, P. O. BOX 10356, PALO ALTO, CA, 94303, US

(21) Appl. No.: 09/933,696

(22) Filed: Aug. 20, 2001

Related U.S. Application Data
(63) Continuation-in-part of application No. 09/892,015, filed on Jun. 25, 2001.
(63) Continuation-in-part of application No. 09/870,879, filed on May 30, 2001.
(63) Continuation-in-part of application No. 09/584,832, filed on May 31, 2000.
(63) Continuation-in-part of application No. 09/709,948, filed on Nov. 10, 2000.
(63) Continuation-in-part of application No. 09/841,792, filed on Apr. 24, 2001.

(51) Int. Cl. H04N 7/16

(52) U.S. Cl. 725/87; 725/91

(57) ABSTRACT

The present invention teaches a method for selectively preventing the access by a client to data-on-demand (DOD) services comprising the acts of: receiving at least one DOD service, and receiving at least one associated expiration information packet corresponding to the at least one DOD service, wherein the at least one expiration information packet indicates a first predetermined time after which the at least one DOD service may no longer be accessed; and storing at least a portion of the at least one DOD service in a memory location. In a second embodiment the method further comprises the act of receiving at least one associated copy protection information packet corresponding to the at least one DOD service, wherein the at least one copy protection information packet indicates a second predetermined time after which copying of the at least one DOD service will be hindered.

### RELATED APPLICATIONS

This application is a continuation-in-part claiming priority to Khoi Nhu Hoang's patent applications entitled COUNTERFEIT STB PROTECTION THROUGH PROTOCOL SWITCHING filed on Jun. 25, 2001, bearing application Ser. No. 09/892,015, UNIVERSAL STB ARCHITECTURES AND CONTROL METHODS filed on May 30, 2001, bearing application Ser. No. 09/870,879, SYSTEMS AND METHODS FOR PROVIDING VIDEO ON DEMAND SERVICES FOR BROADCASTING SYSTEMS filed on May 31, 2000, bearing application Ser. No. 09/584,832, METHODS FOR PROVIDING VIDEO ON DEMAND SERVICES FOR BROADCASTING SYSTEMS filed Nov. 10, 2000, bearing application Ser. No. 09/709,948 and UNIVERSAL DIGITAL BROADCAST SYSTEM AND METHODS filed on Apr. 24, 2001, bearing application Ser. No. 09/841,792, all five being incorporated herein by reference.

### BACKGROUND OF THE INVENTION

1. Field of the invention

The present invention relates to data-on-demand (DOD) and digital broadcast technology. In particular, the present invention teaches a method and apparatus for inactivating DOD programs and preventing reproduction of DOD programs.

2. Description of the prior art

Data-on-demand (DOD) systems are a new alternative to traditional cable television systems which provide services at regularly scheduled times. One problem faced in the video-on-demand (VOD) and DOD industry is preventing clients from simply recording DOD services. This reduces repeat orders for previously received DOD services, and may lead to illicit sharing or selling of DOD services to non-clients. Another problem is that once a client has downloaded a DOD service he may use the service indefinitely. Once a client has ordered a selected DOD service he or she never needs to order that service again.

The following is a general discussion of widely used digital broadcast systems. Generally in digital broadcast systems, a bit stream, multiplexed in accordance with the MPEG-2 standard, is a “transport stream” constructed from “packetized elementary stream” (or PES) packets and packets containing other necessary information. A “packetized elementary stream” (or PES) packet is a data structure used to carry “elementary stream data.” An “elementary stream” is a generic term for one of (a) coded video, (b) coded audio, or (c) other coded bit streams carried in a sequence of PES packets with one stream ID. Transport streams support multiplexing of video and audio compressed streams from one program with a common time base.

PRIOR ART FIG. 1 illustrates the packetizing of compressed video data 106 of a video sequence 102 into a stream of PES packets 108, and then, into a stream of transport stream packets 112. Specifically, a video sequence 102 includes various headers 104 and associated compressed video data 106. The video sequence 102 is parsed into variable length segments, each having an associated PES packet header 110 to form a PES packet stream 108. The PES packet stream 108 is then parsed into segments, each of which is provided with a transport stream header 114 to form a transport stream 112.

PRIOR ART FIG. 2 is a block schematic showing a digital broadcast system 200 including a digital broadcast server 202 and a set-top-box 204 suitable for processing digital broadcast data. At the digital broadcast server 202, video data is provided to a video encoder 206 which encodes the video data in accordance with the MPEG-2 standard. The video encoder 206 provides encoded video 208 to a packetizer 210 which packetizes the encoded video 208. The packetized encoded video 212 provided by the packetizer 210 is then provided to a transport stream multiplexer 214.

Similarly, at the digital broadcast server 202, audio data is provided to an audio encoder 214 which encodes the audio data. The audio encoder 214 provides encoded audio 218 to a packetizer 220 which packetizes the encoded audio 218. The packetized encoded audio 222 provided by the packetizer 220 is then provided to the transport stream multiplexer 214.

The transport stream multiplexer 214 multiplexes the encoded audio and video packets and transmits the resulting multiplexed stream to a set-top-box 204 via distribution infrastructure 224. This distribution infrastructure 224 may be, for example, a telephone network and/or a cable TV (CATV) system, employing optical fiber and implementing asynchronous transfer mode (ATM) transmission protocols. At the set-top-box 204, on a remote end of the distribution infrastructure 224, a transport stream demultiplexer 230 receives the multiplexed transport stream. Based on the packet identification number of a particular packet, the transport stream demultiplexer 230 separates the encoded audio and video packets and provides the video packets to a video decoder 232 via link 238 and the audio packets to an audio decoder 236 via link 240.

The transport stream demultiplexer 230 also provides timing information to a clock control unit 236. The clock control unit 236 provides timing outputs to the both the video decoder 232 and the audio decoder 236 based on the timing information provided by the transport stream demultiplexer 230 (e.g., based on the values of PCR fields). The video decoder 232 provides video data which corresponds to the video data originally provided to the video encoder 206. Similarly, the audio decoder 236 provides audio data which corresponds to the audio data originally provided to the audio encoder 216.

PRIOR ART FIG. 3 shows a simplified functional block diagram of a VOD system 300. At the heart of the VOD system 300 is the video server 310 which routes the digital movies, resident in the movie storage system 312, to the distribution infrastructure 314. This distribution infrastructure 314 may be, for example, a telephone network and/or a cable TV (CATV) system, employing optical fiber and implementing asynchronous transfer mode (ATM) transmission protocols. The distribution infrastructure 314 delivers movies to individual homes based on the routing information supplied by the video server 310.

The VOD system 300 also includes a plurality of VOD STBs 304 suitable for processing VOD in the VOD system 300. Each STB 304 receives and decodes a digital movie and converts it to a signal for display on a TV set or A/V monitor.

PRIOR ART FIG. 4 illustrates a general diagram of a DOD system 320 having a bi-directional client-server architecture. The DOD system 322 includes a DOD server 322 bidirectionally coupled with a plurality of DOD clients 324 vi a communication link 326. As will be appreciated, the VOD system 300 of FIG. 3 is a somewhat specific example of the DOD system 320.

Broadly speaking, the DOD system 320 operation adheres to the well known client-server model as follows. In some manner, typically through transmission of an Electronic Program Guide (EPG) by the DOD server 322, the clients 324 are informed of available on-demand data. Using the EPG for reference, a requesting DOD client 324 requests specific data from the DOD server 322 via the communication link 326. The DOD server 322 interprets the client request, and then prepares the client specific data in a format suitable for use by the requesting client 324.

Once the client specific data is prepared, the server 322 transmits the client specific data to the requesting client 324. The requesting client 324 receives, via a specifically allocated portion of the communication link 326, the requested client specific data in a readably usable format. The requested client specific data is provided in a format ready for presentation by the DOD client to the end user. These client-server processes are described below in more detail with reference to FIGS. 5-6.

Although communication link 326 may be a true bi-directional communications medium, such infrastructure is uncommon. Instead, typical implementations today cobble together existing infrastructure such as fiber optic cabling and telephone lines to implement the necessary bi-directional communications. For example, the fiber optic cable may be used for server transmission of client specific data while an existing telephone line may be used for client transmission of requests.

Turning next to PRIOR ART FIG. 5, a bi-directional DOD server method 340 in accordance with the prior art will now be described. In a first step 342, the DOD server identifies the available slots within the available transmission bandwidth. In a next step 344 the DOD server prepares and transmits a suitable EPG to each client. It will be appreciated that different EPGs may be transmitted for different clients depending upon factors such as subscription levels, available services, personalized settings, payment history, etc. In any event, in a next step 346, the DOD server receives a demand for specific data from a specific client. N The demand includes information indicating the identity of the client. Then in a step 348, the DOD server identifies the specific client from information included with the demand. Step 348 may include such actions as retrieving the client specific data from a persistent storage mechanism and preparing an appropriate channel server for data transmission.

At a step 350, the DOD server assigns an available slot to the client. In step 352, the DOD server prepares the requested client specific data for transmission in a format suitable for the requesting client. Continuing with a step 354, the DOD server transmits the client specific data via the bandwidth allocated to the requesting client.

In a step 356 the receiving client's set-top-box (STB) stores the requested DOD service on an internal hard drive. This DOD service may be accessed by the client at any time. DOD services such as movies may be recorded by a VCR attached to the STB. No mechanism is available for preventing the client from accessing this stored service at some future time. No mechanism is available for preventing unlimited copying of this stored service.

Turning next to FIG. 6, a client method 360 for retrieving on-demand data will now be described. In a tuning step 362, the DOD client will tune into the appropriate channel program and in a receiving step 364 the DOD client will receive the EPG transmitted by the DOD server. In a next step 366, the DOD client provides the EPG information to a DOD user and in a step 368, receives a request for specific data from the DOD user. Then in a step 370, the DOD client demands that the DOD server provide the requested client specific data. In a step 372, in anticipation of the requested client specific data, the DOD client tunes into the allocated bandwidth. Then in a step 374, the DOD client receives via allocated bandwidth the requested client specific data in a readably usable format. Then in step 376, the client stores the requested data on a DOD receiver having an internal hard drive. The stored data being available for use by the client for an indefinite period.

As the above discussion reflects, none of the prior art systems provide a method for limiting the useful life of downloaded DOD services. None of the prior art systems provide a method for limiting the copying or quality of copying of downloaded DOD services. Therefore, it is desirable to provide a method for limiting the useful life of downloaded DOD services. Furthermore, it is desirable to provide a method for limiting the quality of copies made from downloaded DOD services. What is also needed is a method for limiting the copying of downloaded DOD service.

### SUMMARY

The present invention teaches methods and systems for selectively deactivating DOD services such that a DOD service that has been received and stored by a DOD receiver will only be accessible for a limited time period. The present invention also teaches methods and systems for limiting the quality of copies made from downloaded DOD services. These include a universal digital data system, a universal STB, and a variety of methods for handling these digital services and controlling the universal STB.

A first embodiment of the present invention teaches a method for selectively preventing the access by a client to data-on-demand (DOD) services comprising the acts of: receiving at least one DOD service, and receiving at least one associated expiration information packet corresponding to the at least one DOD service, wherein the at least one expiration information packet indicates a first predetermined time after which the at least one DOD service may no longer be accessed; and storing at least a portion of the at least one DOD service in a memory location. In a second embodiment the method further comprises the act of receiving at least one associated copy protection information packet corresponding to the at least one DOD service, wherein the at least one copy protection information packet indicates a second predetermined time after which copying of the at least one DOD service will be hindered.

It is important to remark that as types of set-top boxes become more ubiquitous, they are often built-in to a unit, such as a TV or computer, rather than actually set on top or beside. One of ordinary skill in the art would recognize that all references to STBs would apply equally to built-in version, and thus the two become synonymous.

### BRIEF DESCRIPTION OF THE DRAWINGS

PRIOR ART FIG. 1 illustrates pictorially the packetizing of compressed video data into a stream of packets and a stream of transport packets;

PRIOR ART FIG. 2 illustrates by block diagram a system according to the MPEG-2 standard;

PRIOR ART FIG. 3 illustrates a simplified functional block diagram of a VOD system;

PRIOR ART FIG. 4 illustrates a DOD system adhering to a prior art bi-directional client-server architecture;

PRIOR ART FIG. 5 illustrates a DOD server method for providing DOD services using a client specific data transmission mechanism;

PRIOR ART FIG. 6 illustrates a DOD client method for receiving and storing DOD services using a DOD receiver mechanism;

FIG. 7 is a block diagram of a digital broadcast server in accordance with one embodiment of the present invention;

FIG. 8 is a block diagram showing the hardware architecture of a universal STB in accordance with a preferred embodiment of the present invention;

FIG. 9 is a flow chart illustrating a computer implemented method for receiving DOD services having a limited useful lifespan in accordance with one embodiment of the present invention;

FIG. 10 is a flow chart illustrating a computer executable method for accessing selected DOD services having associated expiration information stored in a DOD receiver in accordance with one embodiment of the present invention;

FIG. 11 is a flow chart illustrating a computer executable method for accessing selected DOD services having associated copy protection information in accordance with one embodiment of the present invention;

FIG. 12 is a flow chart illustrating a computer implemented method for receiving DOD services having copy protection in accordance with one embodiment of the present invention; and

FIG. 13 is a flow chart illustrating a copy prevention process for DOD services previously stored in accordance with the process of FIG. 12.

### DETAILED DESCRIPTION OF THE PREFERRED EMBODIMENTS

In the following detailed description of the embodiments, reference is made to the drawings that accompany and that are a part of the embodiments. The drawings show, by way of illustration, specific embodiments in which the invention may be practiced. Those embodiments are described in sufficient detail to enable those skilled in the art to practice the invention and it is to be understood that other embodiments may be utilized and that structural, logical, and electrical changes as well as other modifications may be made without departing from the spirit and scope of the present invention.

The present invention teaches methods and systems for selectively deactivating DOD services such that a DOD service that has been received and stored at a DOD receiver will only be accessible for a limited time period. The present invention also teaches methods and systems for limiting the quality of copies made from downloaded DOD services. These include a universal digital data system, a universal STB, and a variety of methods for handling these digital services and controlling the universal STB. Though the forgoing describes the present invention as being used in a uni-directional broadcast system, the present invention may be applied equally to a bi-directional broadcast system.

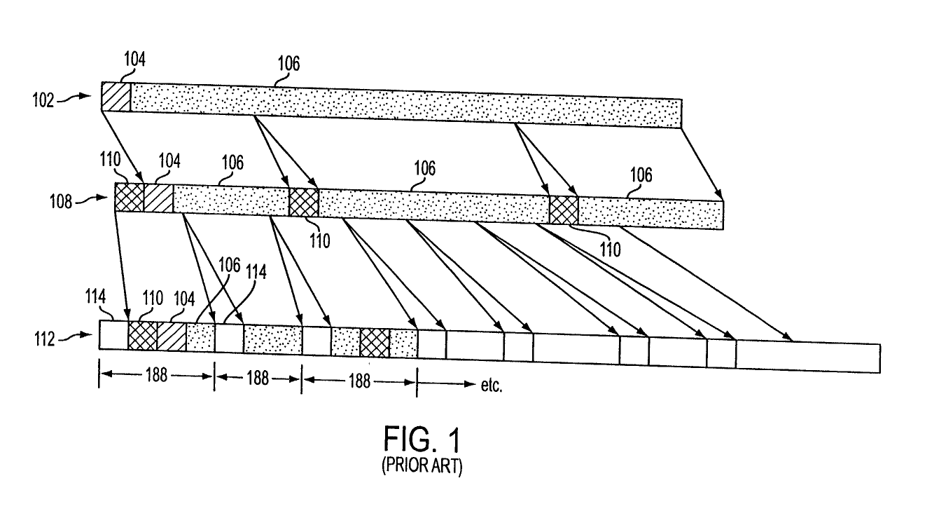

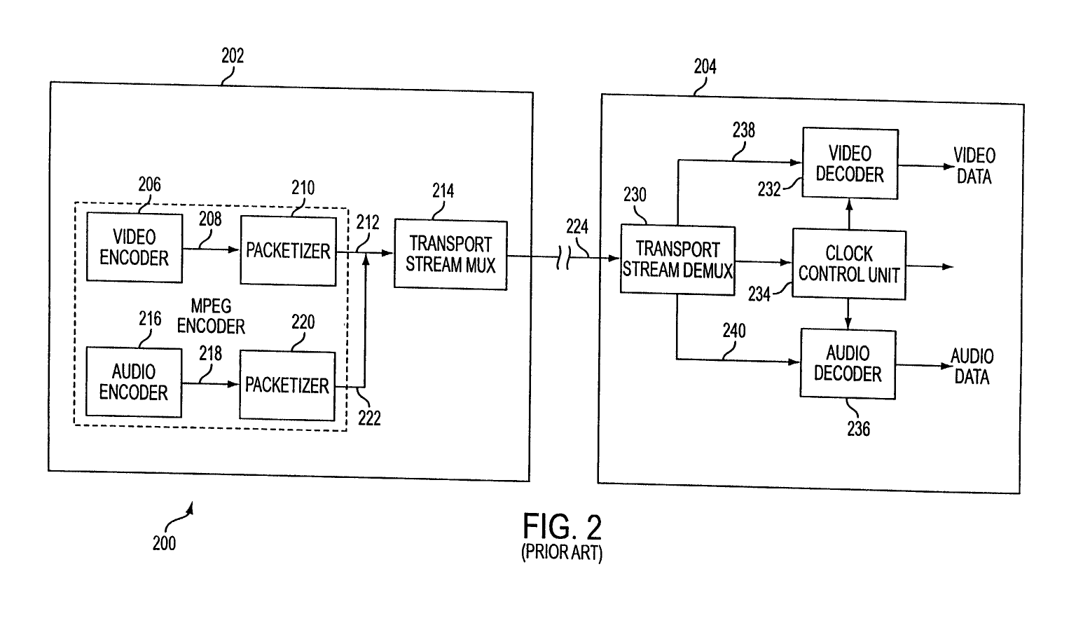

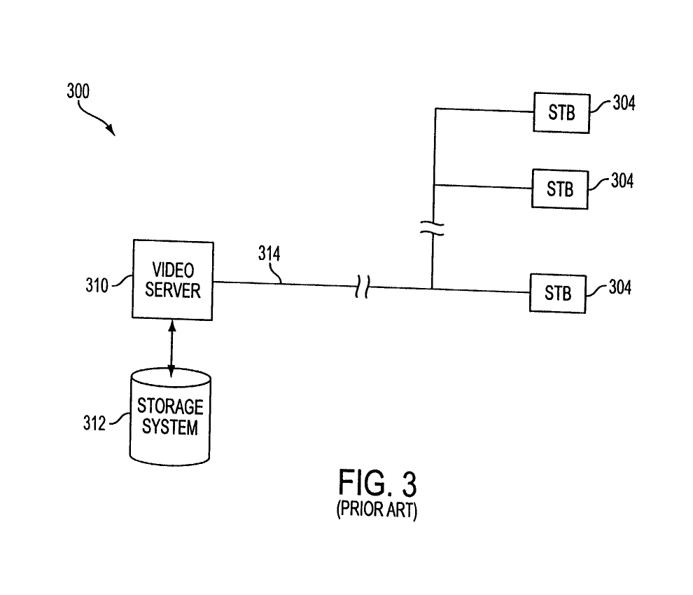

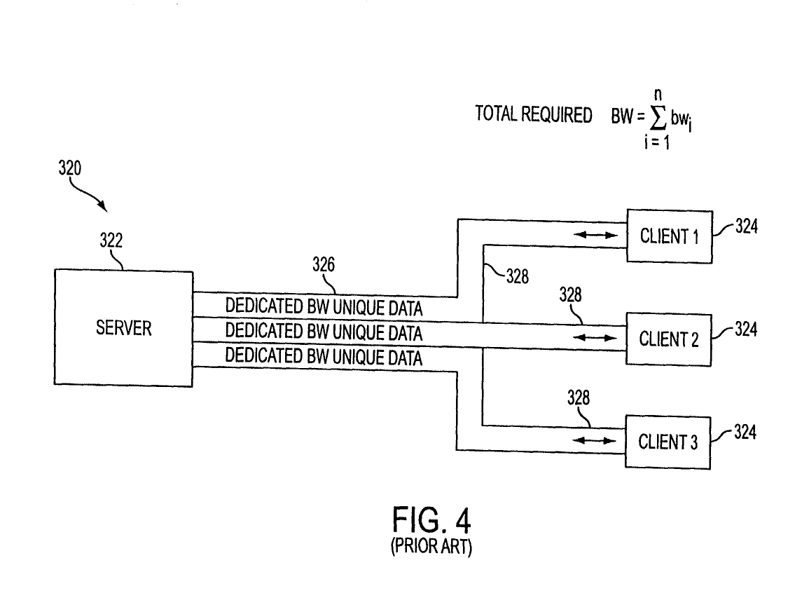

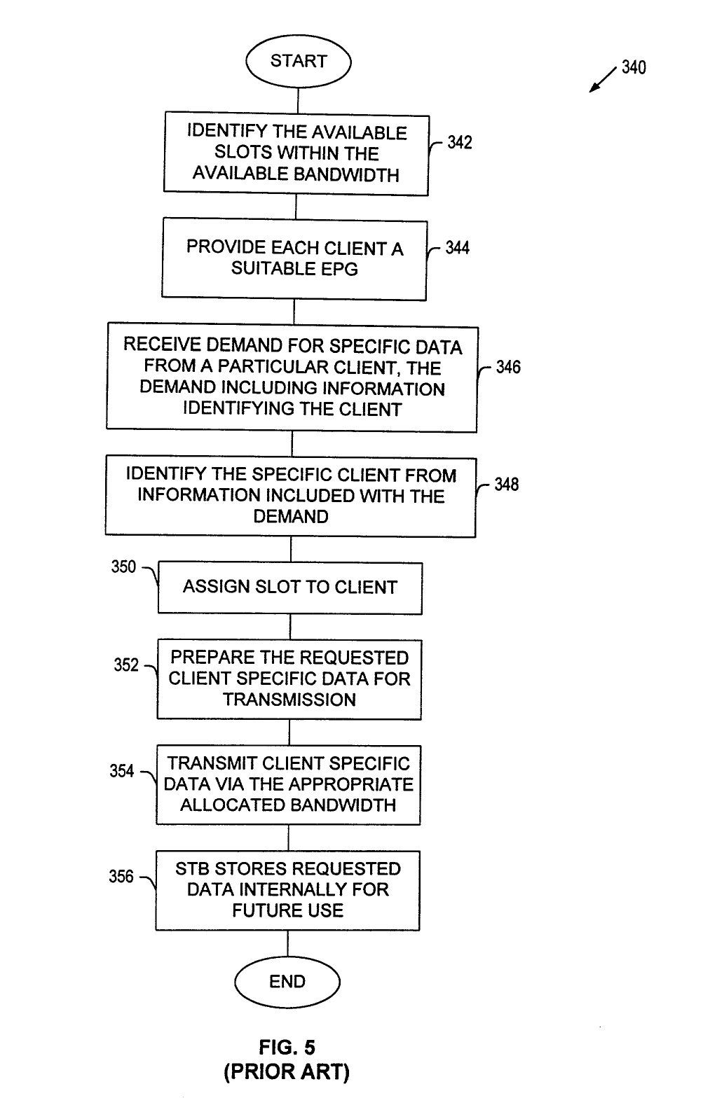

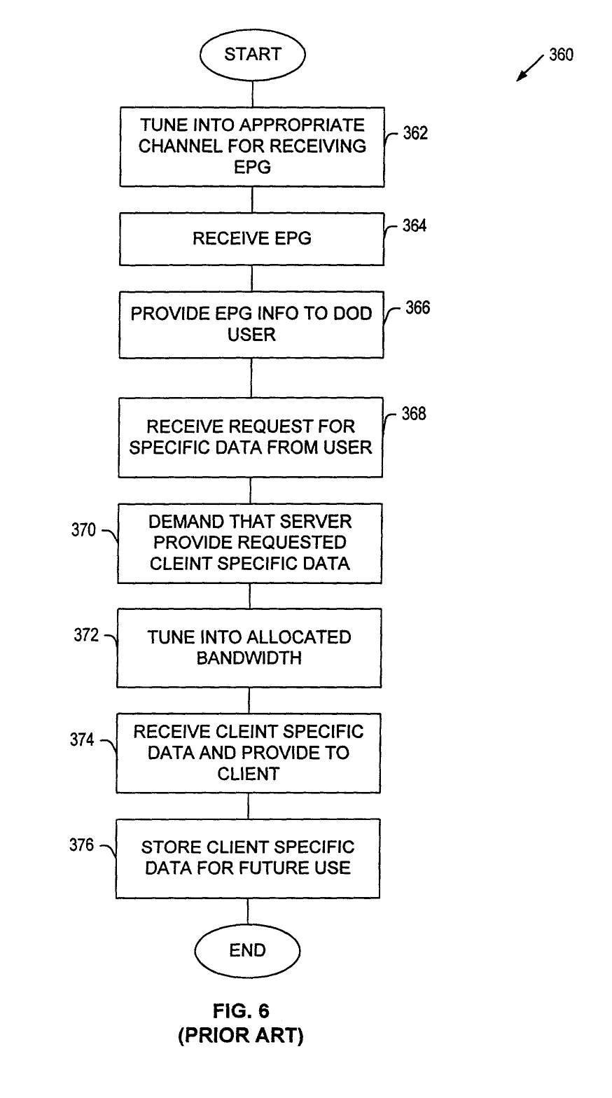

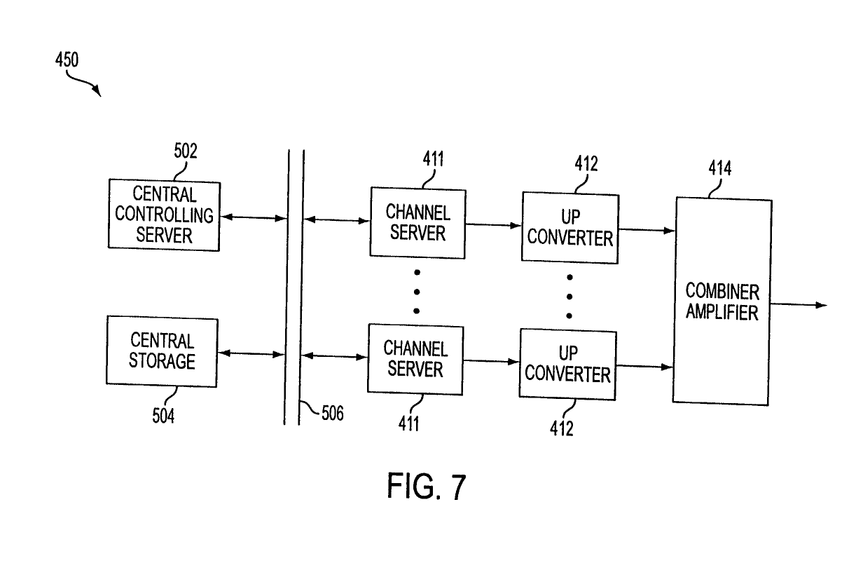

FIG. 7 illustrates the architecture for a DOD server 450 in accordance with one embodiment of the present invention. The DOD server 450 includes a plurality of channel servers 411, a plurality of up converters 412 each corresponding to a channel server 411, a combiner amplifier 414, a central controlling server 502, and a central storage 504, coupled as illustrated through a data bus 506. As will be described below, the central controlling server 502 controls off-line operation of the channel servers 411, as well as initiating real-time transmission once the channel servers 411 are ready. The central storage 504 typically stores data files in a digital format. However, any suitable mass persistent data storage device may be used.

In an exemplary embodiment, data files stored in the central storage 504 are accessible via a standard network interface (e.g., Ethernet connection) by any authorized computer, such as the central controlling server 502, connected to the network. The channel servers 411 provide data files that are retrieved from the central storage 504 in accordance with instructions from the central controlling server 502. The retrieval of digital data and the scheduling of transmission of the digital data for DOD is performed “off-line” to fully prepare each channel server 411 for real-time data transmission. Each channel server 411 informs the central controlling server 502 when ready to provide DOD, at which point the central controlling server 502 can control the channel servers 411 to begin DOD transmission.

In a preferred embodiment, the central controlling server 502 includes a graphics user interface (not shown) to enable a service provider to schedule data delivery by a drag-and-drop operation. Further, the central controlling server 502 authenticates and controls the channel servers 410 to start or stop according to delivery matrices. Systems and methods for providing uni-directional DOD broadcast matrices are taught in Khoi Hoang's patent application entitled SYSTEMS AND METHODS FOR PROVIDING VIDEO ON DEMAND SERVICES FOR BROADCASTING SYSTEMS filed on May 31, 2000, bearing application Ser. No. 09/584,832, which is incorporated herein by reference.

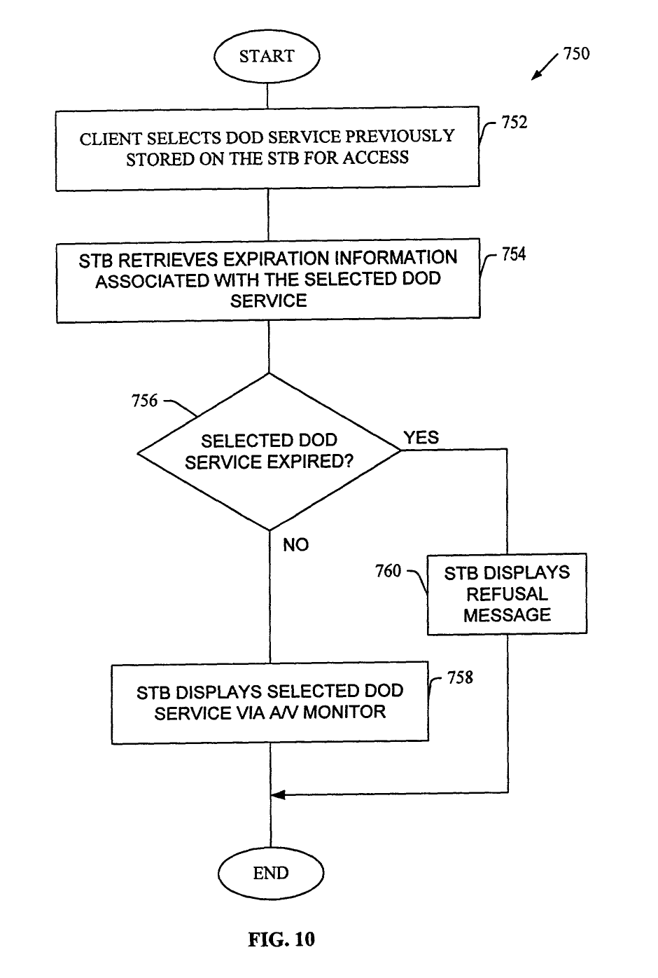

Each channel server 411 is assigned to a channel and is coupled to an up-converter 412. The output of each channel server 411 is a quadrature amplitude modulation (QAM) modulated intermediate frequency (IF) signal having a suitable frequency for the corresponding up-converter 412. The QAM-modulated IF signals are dependent upon adopted standards. The current adopted standard in the United States is the data-over-cable-systems-interface-specification (DOCSIS) standard, which requires an approximately 43.75 MHz IF frequency. A preferred channel server 411 is described below in more detail with reference to FIG. 10.

The up-converters 412 convert IF signals received from the channel servers 104 to radio frequency signals (RF signals). The RF signals, which include frequency and bandwidth, are dependent on a desired channel and adopted standards. For example, under the current standard in the United States for a cable television channel 80, the RF signal has a frequency of approximately 559.25 MHz and a bandwidth of approximately 6 MHz.

The outputs of the up-converters 412 are applied to the combiner/amplifier 414. The combiner/amplifier 414 amplifies, conditions and combines the received RF signals then outputs the signals out to a transmission medium.

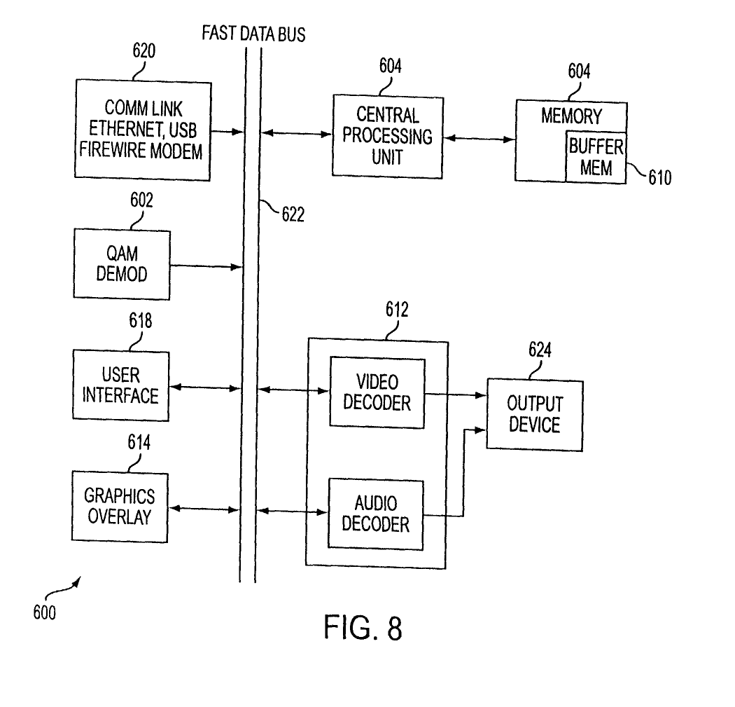

FIG. 8 illustrates a universal STB 600 in accordance with one embodiment of the invention. The STB 600 comprises a QAM demodulator 602, a CPU 604, a local memory 608, a buffer memory 610, a decoder 612 having video and audio decoding capabilities, a graphics overlay module 614, a user interface 618, a communications link 620, and a fast data bus 622 coupling these devices as illustrated. The CPU 602 controls overall operation of the universal STB 600 in order to select data in response to a client's request, decode selected data, decompress decoded data, re-assemble decoded data, store decoded data in the local memory 608 or the buffer memory 610, and deliver stored data to the decoder 612. In an exemplary embodiment, the local memory 608 comprises both non-volatile memory and secure memory, and the buffer memory 610 comprises volatile memory.

In one embodiment, the QAM demodulator 602 comprises transmitter and receiver modules and one or more of the following: privacy encryption/decryption module, forward error correction decoder/encoder, tuner control, downstream and upstream processors, CPU and memory interface circuits. The QAM demodulator 602 receives modulated IF signals, samples and demodulates the signals to restore data.

In an exemplary embodiment, when access is granted, the decoder 612 decodes at least one data block to transform the data block into images displayable on an output screen. The decoder 612 supports commands from a subscribing client, such as play, stop, pause, step, rewind, forward, etc. The decoder 612 provides decoded data to an output device 624 for use by the client. The output device 624 may be any suitable device such as a television, computer, any appropriate display monitor, a VCR, or the like.

The graphics overlay module 614 enhances displayed graphics quality by, for example, providing alpha blending or picture-in-picture capabilities. In an exemplary embodiment, the graphics overlay module 614 can be used for graphics acceleration during game playing mode, for example, when the service provider provides games-on-demand services using the system in accordance with the invention.

The user interface 618 enables user control of the STB 600, and may be any suitable device such as a remote control device, a keyboard, a smartcard, etc. The communications link 620 provides an additional communications connection. This may be coupled to another computer, or may be used to implement bi-directional communication. The data bus 622 is preferably a commercially available “fast” data bus suitable for performing data communications in a real time manner as required by the present invention. Suitable examples are USB, firewire, etc.

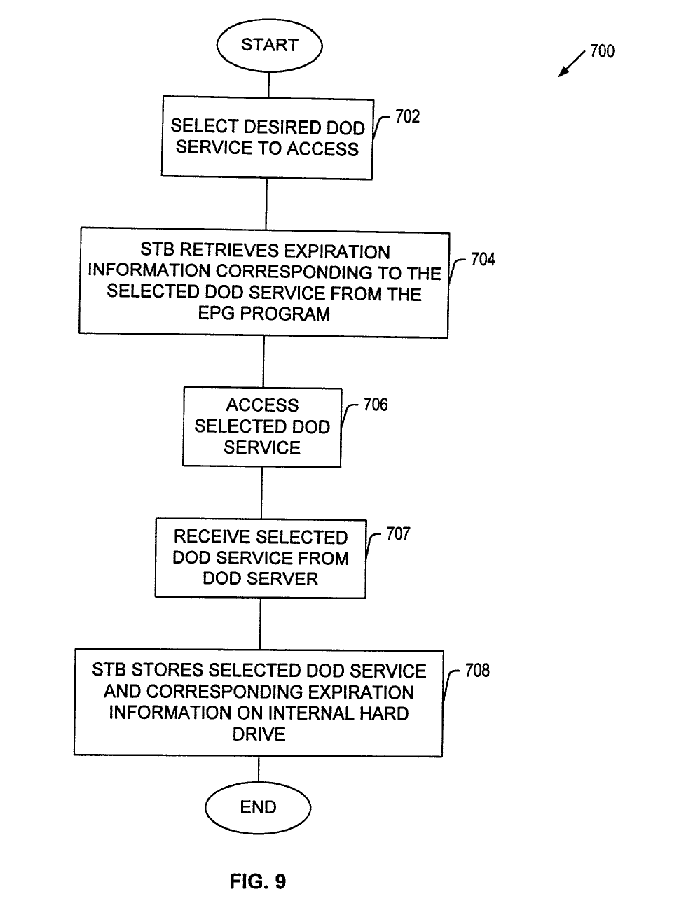

FIG. 9 shows a process for receiving a DOD service at 700 in accordance with one embodiment of the present invention. The process 700 begins at step 702, in which a client selects a desired DOD service from the DOD services available from a DOD server 450 (FIG. 7) using the user interface 618 (FIG. 8). This may involve selecting a program for viewing from a listing of available DOD programs on the EPG. A service may also be selected by entering a code corresponding to the desired service using the user interface. Once a DOD service is selected the process continues to step 704, at which the STB retrieves expiration information from the EPG program corresponding to the selected DOD service. In a preferred embodiment >X every available DOD service has associated expiration information available via the EPG program. Then in step 706, the STB tunes in to the appropriate bandwidth and the appropriate broadcast data in order to receive the selected DOD service. In step 707, the STB receives the selected DOD service via a data stream transmitted by the DOD server 450 (FIG. 7).

In step 708 the STB stores the received DOD service and corresponding expiration information on an internal hard drive 608 (FIG. 8) for future use. Alternatively the DOD service and corresponding expiration information could be stored on a mobile storage medium such as a zip disk or CD re-write disk. In such an alternative embodiment the DOD service would be stored in such a way as to only be accessible by STB's equipped for reading the stored expiration information.

FIG. 10 shows an STB process for accessing stored DOD services at 750 in accordance with one embodiment of the present invention. The process begins at step 752, in which a user selects a DOD service that has been previously stored in an STB in step 708 (FIG. 9) to be accessed using the user interface 618 (FIG. 8). This may involve selecting a program for viewing from a menu listing available DOD services stored on the STB, displayed by the user interface.

In a step 754, the STB retrieves the expiration information corresponding to the selected DOD service from the memory 608. In step 756, the STB 600 (FIG. 8) determines whether the selected DOD service is expired. This determination is made by the processor 604 (FIG. 8), which compares an expiration date included in the expiration information with the current date. If the date indicated in the expiration information stored in memory is later than the current date indicated by the EPG program, then the process continues to step 758. At step 758 the STB retrieves the selected DOD service for use by the client. In step 759 the STB displays any graphical elements of the selected DOD service on an A/V monitor or television set.

If the selected stored DOD service has expired, the process proceeds to a step 760. At step 760 the STB displays a refusal message to the user. This message may include information such as instructions for re-accessing the expired DOD service.

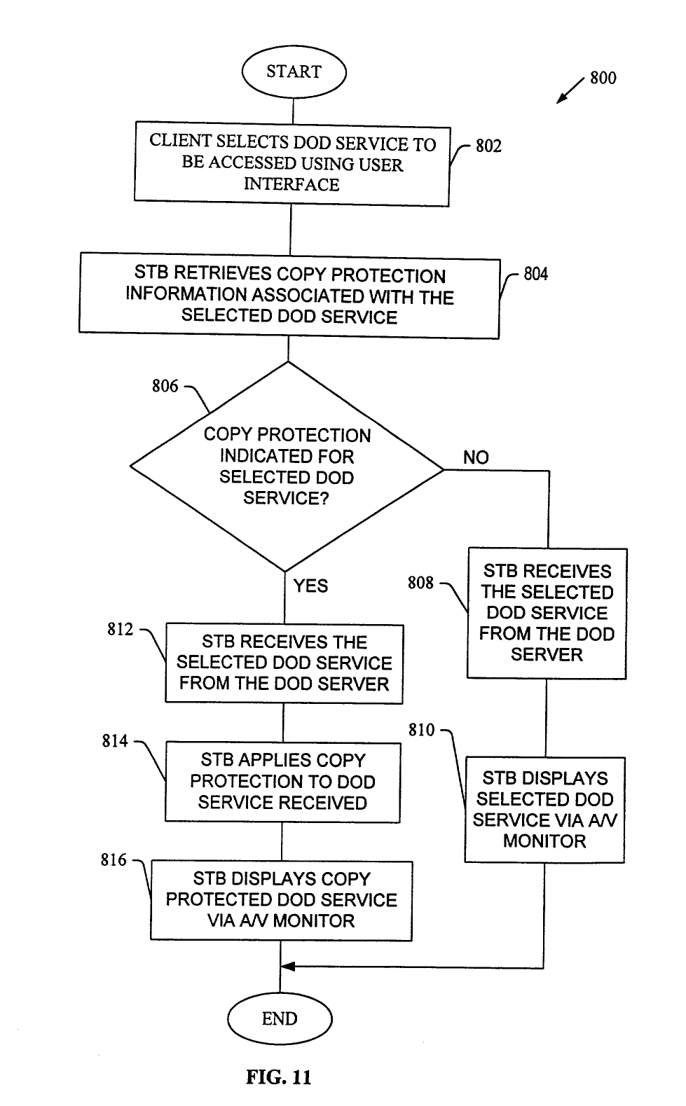

FIG. 11 shows a copy prevention process at 800 in accordance with one embodiment of the present invention. The process begins at step 802, in which a user selects a DOD service to be accessed using the user interface 618 (FIG. 8). This may involve selecting a program for viewing from a listing of available DOD programs on the EPG. A DOD service may also be selected by entering a code corresponding to the desired service.

In a step 804, the STB retrieves copy protection information corresponding to the selected DOD service from the EPG program. In accordance with one embodiment each DOD service has associated copy protection information accessible by the STB via the EPG program. At a step 806, the STB determines whether copy protection is to be applied to the selected DOD service based on the copy protection information. If no copy protection is indicated the process continues to step 808, at which the STB 600 (FIG. 8) receives the selected DOD service from the server 450 (FIG. 7). Then at a step 810 the STB displays any graphical elements of the selected DOD service to a user via an A/V monitor, VCR or the like. The display may be freely copied to video tape or DVD.

In accordance with an alternative embodiment the associated copy protection information is contained in the headers 110 (FIG. 1) of packet streams carrying the selected DOD service. In such an alternative embodiment the STB retrieves the copy protection information after receiving the DOD service.

If copy protection is indicated by the copy protection information the process proceeds to step 812, at which the STB receives the selected DOD service from the server. Then at a step 814 the STB applies copy protection to the received DOD service before displaying the selected DOD service. This copy protection may include the application of various picture distortion, random wobble, signal noise or color destabilization. Such methods of modifying video signals in order to reduce copy quality are disclosed by U.S. Pat. No. 5,883,936, entitled VIDEO COPY PROTECTION PROCESS ENHANCEMENT TO INTRODUCE HORIZONTAL AND VERTICAL PICTURE DISTORTIONS, which is hereby incorporated by reference. Any other methods of degrading the copy quality of a video signal without diminishing the contemporaneous viewing quality of the video signal known in the art may also be used as copy protection. Such copy protection may be applied either through the use of dedicated circuitry within the STB 600 (FIG. 8) or a software application stored in the STB memory 608 (FIG. 8).

The process then proceeds to step 816, at which the selected DOD service is displayed with the applied copy protection in place. This allows the user to view the selected DOD service normally but causes any copies made of the DOD service to be visually distorted.

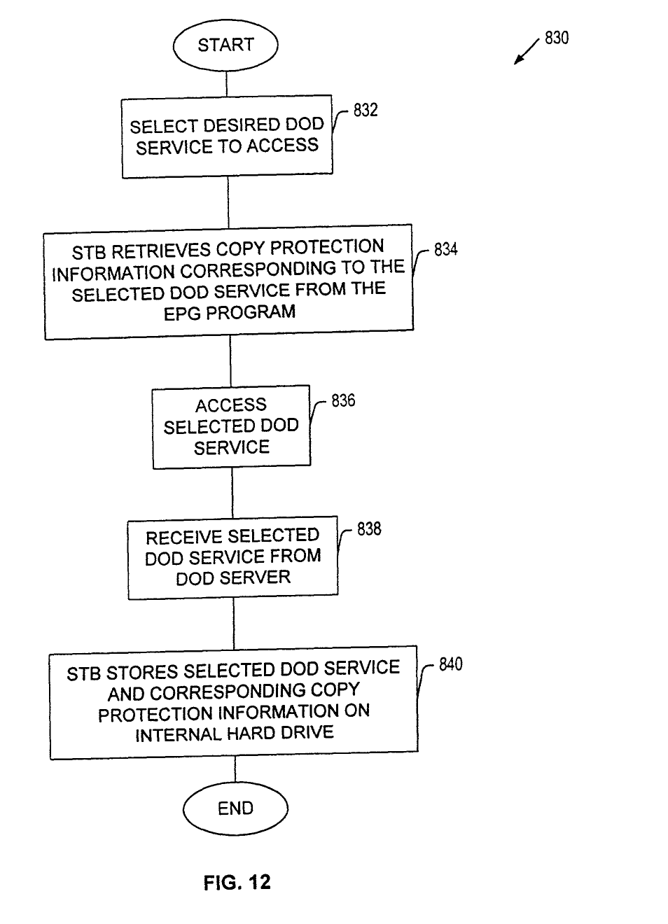

FIG. 12 shows a process for receiving a DOD service having associated copy protection information at 830 in accordance with one embodiment of the present invention. The process 830 begins at step 832, in which a client selects a desired DOD service from the DOD services available from a DOD server 450 (FIG. 7) using the user interface 618 (FIG. 8). This may involve selecting a program for viewing from a listing of available DOD programs on the EPG. A service may also be selected by entering a code corresponding to the desired service using the user interface. Once a DOD service is selected the process continues to step 834, at which the STB retrieves copy protection information from the EPG program corresponding to the selected DOD service. In a preferred embodiment every available DOD service has associated copy protection information available via the EPG program. Then in step 836, the STB tunes in to the appropriate bandwidth and the appropriate broadcast data in order to receive the selected DOD service. In step 838, the STB receives the selected DOD service via a data stream transmitted by the DOD server 450 (FIG. 7).

In step 840 the STB stores the received DOD service and corresponding copy protection information on an internal hard drive 608 (FIG. 8) for future use. Alternatively the DOD service and corresponding expiration information could be stored on a mobile storage medium such as a zip disk or CD re-write disk. In such an alternative embodiment the DOD service would be stored in such a way as to only be accessible by STB's equipped for reading the stored copy protection information.

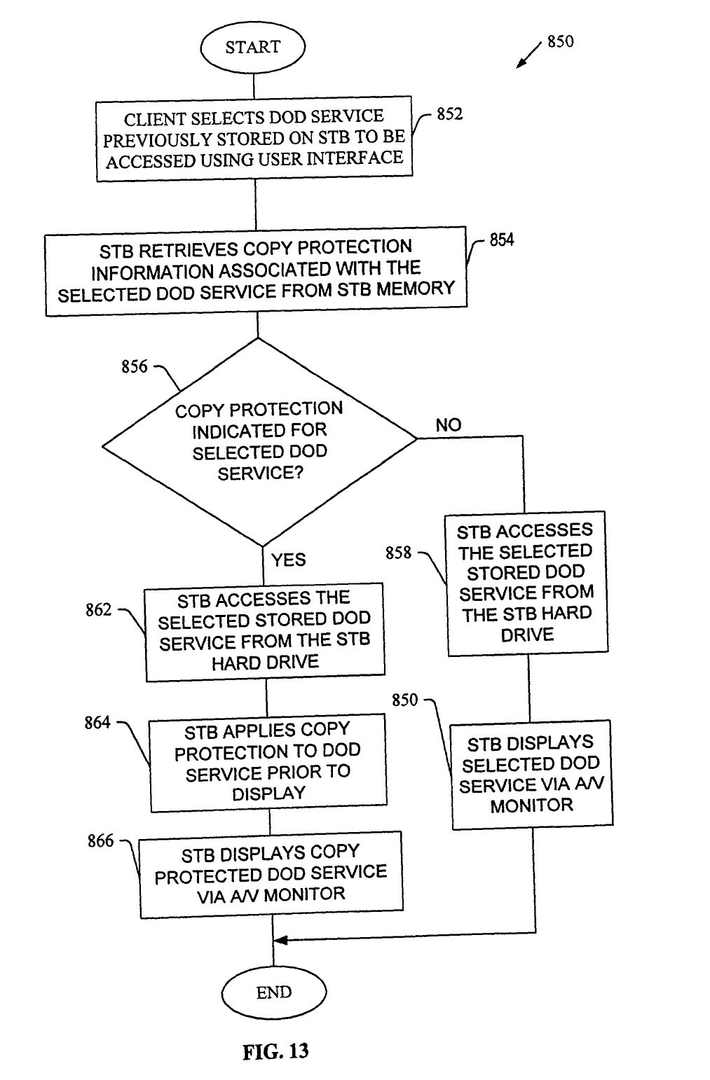

FIG. 13 shows a copy prevention process at 850 for DOD services previously stored in step 840 (FIG. 12) in accordance with one embodiment of the present invention. The process begins at step 852, in which a user selects a DOD service to be accessed from a menu of DOD services stored on the STB hard drive using the user interface 618 (FIG. 8).

In a step 854, the STB retrieves copy protection information corresponding to the selected DOD service from the STB hard drive 608. At a step 856, the STB determines whether copy protection is to be applied to the selected DOD service based on the copy protection information. If no copy protection is indicated the process continues to step 858, at which the STB 600 (FIG. 8) retrieves the selected DOD service from the STB's hard drive memory. Then at a step 860 the STB displays any graphical elements of the selected DOD service to a user via an A/V monitor, VCR or the like. The display may be freely copied to video tape or DVD.

If copy protection is indicated by the copy protection information stored in the STB corresponding to the selected DOD service the process proceeds to step 862, at which the STB retrieves the stored DOD program from the hard drive. Then at a step 864 the STB applies copy protection to the retrieved DOD service before displaying the selected DOD service. This copy protection may include the application of various picture distortion, random wobble, signal noise or color destabilization as discussed in reference to FIG. 11 above. Any other methods of degrading the copy quality of a video signal without diminishing the contemporaneous viewing quality of the video signal known in the art may also be used as copy protection. Such copy-protection may be applied either through the use of dedicated circuitry within the STB 600 (FIG. 8) or a software application stored in the STB memory 608 (FIG. 8).

The process then proceeds to step 866, at which the selected DOD service is displayed with the applied copy protection in place. This allows the user to view the selected DOD service normally but causes any copies made of the DOD service to be visually distorted.

The foregoing examples illustrate certain exemplary embodiments of the invention from which other embodiments, variations, and modifications will be apparent to those skilled in the art. The invention should therefore not be limited to the particular embodiments discussed above, but rather is defined by the following claims.

What is claimed is:

1. A method for providing data-on-demand (DOD) services comprising the acts of:
providing at least one DOD service to at least one client, wherein said at least one DOD service is stored for future access; and
providing at least one associated expiration information packet corresponding to said at least one DOD service to said at least one client, wherein said at least one associated expiration information packet indicates a first predetermined time after which said at DOD service may no longer be accessed.

2. A method as recited in claim 1, wherein said at least one associated expiration information packet is provided to said at least one client via a transmission medium.

3. A method as recited in claim 1, wherein said at least one associated expiration information packet is stored.

4. A method as recited in claim 3, wherein said at least one DOD service is stored with said at least one associated expiration information packet such that said stored at least one DOD service and said at least one associated expiration information packet may be accessed by said at least one client.

5. A method as recited in claim 1, wherein said at least one DOD service is stored on at least one DOD receiver for future access by said at least one client, and further wherein said at least one DOD receiver is operative to access said stored at least one DOD service.

6. A method as recited in claim 5, wherein said first predetermined time is exceeded, said DOD receiver is operative to deny access to said stored at least one DOD service.

7. A method as recited in claim 1, further comprising providing at least one associated copy protection information packet corresponding to said at least one DOD service, wherein said at least one associated copy protection information packet indicates a second predetermined time after which copying of said at least one DOD service is inhibited.

8. A method as recited in claim 7, wherein said at least one DOD service and said at least one associated copy protection information packet is stored on a DOD receiver operative to access said stored at least one DOD service.

9. A method as recited in claim 8, wherein said second predetermined time is exceeded, said DOD receiver is operative to copy protect said stored at least one DOD service.

10. A method as recited in claim 9, wherein said DOD receiver is operative to access said at least one DOD service, and further operative to selectively inhibit copying of said at least one DOD service.

11. A method for selectively preventing the access by a client to data-on-demand (DOD) services comprising the acts of:
receiving at least one DOD service, and
receiving at least one associated expiration information packet corresponding to said at least one DOD service, wherein said at least one expiration information packet indicates a first predetermined time after which said at least one DOD service may no longer be accessed; and
storing at least a portion of said at least one DOD service in a memory location.

12. A method as recited in claim 11, wherein said at least one associated expiration information packet is received from an electronic program guide.

13. A method as recited in claim 11, wherein said storing at least a portion of said at least one DOD service includes storing said at least a portion of said at least one DOD service on a set-top-box (STB) having an internal storage medium, wherein said STB is operative to access at least a portion of said stored DOD service from said internal storage medium.

14. A method as recited in claim 11, wherein said at least one DOD service is received via a transmission medium.

15. A method as recited in claim 11, further comprising the act of receiving at least one associated copy protection information packet corresponding to said at least one DOD service, wherein said at least one copy protection information packet indicates a second predetermined time after which copying of said at least one DOD service will be hindered.

16. A method as recited in claim 15, wherein said received at least one associated copy protection information packet is stored.

17. A method as recited in claim 11, further comprising the act of receiving at least one associated copy protection information packet corresponding to said at least one DOD service, and wherein at least a portion of said at least one DOD service is stored on a DOD receiver operative to degrade copying of said at least one DOD service in response to said copy protection information packet.

18. A method as recited in claim 11, wherein said storing at least a portion of said at least one DOD service in a memory location includes storing at least a portion of said at least one DOD service on a DOD receiver including said memory location, wherein said DOD receiver is operative to prevent access to said stored portion of said at least one DOD service in response to said expiration information packet.

19. A method as recited in claim 18, wherein said DOD receiver is a set-top-box (STB).

20. A method as recited in claim 18, wherein said DOD receiver includes a visual display apparatus operative to display at least a portion of said at least one DOD service.

21. A data-on-demand (DOD) broadcasting system for providing DOD programs that may only be accessed for a limited time to clients comprising:
a DOD server operative to provide at least one DOD program to at least one DOD receiver via a transmission medium, said DOD server further operative to provide at least one associated expiration information packet corresponding to said at least one DOD program in order to enable said at least one DOD receiver to restrict access to said DOD program, wherein said at least one DOD program has expired.

22. A DOD broadcasting system as recited in claim 21, wherein said at least one associated expiration information packet is provided to said at least one DOD reciever via said transmission medium.

23. A DOD broadcasting system as recited in claim 22, wherein said transmission medium includes electromagnetic signals in the general range of radio and television broadcasts.

24. A DOD broadcasting system as recited in claim 22, wherein said transmission medium includes a fiber optic network.

25. A DOD broadcasting system as recited in claim 21, wherein said at least one DOD server is further operative to provide at least one associated copy protection information packet corresponding to said at least one DOD program to said at least one DOD reciever, wherein said at least one associated copy protection information packet indicates a predetermined time after which copying of said at least one DOD service may be restricted.

26. A DOD broadcasting system as recited in claim 21, wherein said transmission medium includes the Internet.

27. A DOD broadcasting system as recited in claim 21, wherein said at least one DOD receiver is operative to restrict access to said at least one DOD program in response to said at least one associated expiration information packet.

28. A DOD broadcasting system as recited in claim 27, wherein said at least one DOD receiver is further operative to degrade copying of said at least one DOD program in response to said at least one copy protection information packet.

29. A DOD broadcasting system as recited in claim 25, wherein said at least one DOD receiver is a set-top-box (STB).

30. A DOD broadcasting system as recited in claim 25, wherein said DOD receiver includes a visual display apparatus operative to display at least a portion of said at least one DOD service.

31. A set-top-box (STB) for receiving data-on-demand comprising:
a databus;
a first communication device suitable for coupling to a digital broadcast communications medium, said first communication device operable to receive digital broadcast data, wherein said digital broadcast data includes at least one DOD service;
memory bi-directionally coupled to said databus, said memory including computer executable instructions for:
a) reading at least a portion of said digital broadcast data, said digital broadcast data including expiration information associated with said DOD service;
b) determining whether said received DOD service is expired based on said expiration information; and
c) when said DOD service is expired, preventing access to said DOD service;
a digital data decoder bi-directionally coupled to said databus; a central processing unit (CPU) bi-directionally coupled to said databus, said CPU implementing a STB control process controlling said memory, said first communications device and said digital decoder, said STB control process operable to process digital data received at said first communications device.

32. A STB as recited in claim 31, wherein said memory includes transient random access memory (RAM) and a persistent storage device, and said computer executable instructions are stored on said persistent storage device.

33. A STB as recited in claim 32, wherein said persistent storage device is a hard disk.

34. A STB as recited in claim 31, wherein said digital broadcast data further includes copy protection information.
